(19) United States
(12) Patent Application Publication
(10) Pub. No.: US 2024/0249338 A1
(43) Pub. Date: Jul. 25, 2024

(54) INFORMATION PROCESSING APPARATUS, INFORMATION PROCESSING METHOD, AND INFORMATION PROCESSING PROGRAM

(71) Applicant: ZOZO, Inc., Chiba (JP)

(72) Inventors: Takuya UEDA, Chiba (JP); Kengo ONO, Chiba (JP); Yasuhiro MORITA, Chiba (JP); Fuminori ANDO, Chiba (JP)

(21) Appl. No.: 18/566,046

(22) PCT Filed: Aug. 3, 2022
(86) PCT No.: PCT/IB2022/057196

§ 371 Date: Nov. 30, 2023

(30) Foreign Application Priority Data
Jun. 4, 2021 (JP) 2021-094804

(51) Int. Cl. G06Q 30/0601; G06Q 30/0251

(52) U.S. Cl. CPC G06Q 30/0631; G06Q 30/0251; G06Q 30/0641

(57) ABSTRACT

An information processing apparatus includes a first acquisition unit acquiring body shape information on a body shape of a first user, a second acquisition unit acquiring body shape information on a target user that is determined in advance as a user to whom information is to be provided by an information provider, a calculation unit calculating, based on comparison between the body shape information on the first user and statistical data of body shape information based on attribute information on the first user, a difference from a standard body shape that is based on the statistical data, and a providing unit providing information that is suitable for the first user among pieces of information of the information provider for which the body shape information on the target user includes the body shape information on the first user in accordance with the difference that is calculated by the calculation unit.

### FIELD

The present invention relates to an information processing apparatus, an information processing method, and an information processing program.

### BACKGROUND

Conventionally, a technology for proposing a target object, such as clothes, to a user is known. For example, a technology for proposing a target object that fits a body shape of a user based on body information on the user is known.

### CITATION LIST

### Patent Literature

Japanese Laid-open Patent Publication No. 2020-144503

### SUMMARY

### Technical Problem

However, in the conventional technology, it is difficult to improve services in accordance with a target body shape of a user while preventing damage of personal information.

The present application has been conceived in view of the foregoing situation, and an object of the present application is to promote improvement in services in accordance with a target body shape of a user while preventing damage of personal information.

### Solution to Problem

According to the present disclosure, an information processing apparatus includes: a first acquisition unit that acquires body shape information on a body shape of a first user; a second acquisition unit that acquires body shape information on a target user that is determined in advance as a user to whom information is to be provided by an information provider; a calculation unit that calculates, based on comparison between the body shape information on the first user acquired by the first acquisition unit and statistical data of body shape information that is based on attribute information on the first user, a difference from a standard body shape that is based on the statistical data; and a providing unit that provides information that is suitable for the first user among pieces of information of the information provider for which the body shape information on the target user includes the body shape information on the first user in accordance with the difference that is calculated by the calculation unit.

### Advantageous Effects of Invention

According to one aspect of embodiments, it is possible to promote improvement in services in accordance with a target body shape of a user while preventing damage of personal information.

### BRIEF DESCRIPTION OF DRAWINGS

FIG. 1 is a diagram illustrating a configuration example of an information processing system according to one embodiment.

FIG. 2 is a diagram illustrating an example of information processing according to one embodiment.

FIG. 3 is a diagram illustrating a configuration example of a terminal apparatus according to one embodiment.

FIG. 4 is a diagram illustrating a configuration example of an information processing apparatus according to one embodiment.

FIG. 5 is a diagram illustrating an example of a body shape information storage unit according to one embodiment.

FIG. 6 is a diagram illustrating an example of a purchase history storage unit according to one embodiment.

FIG. 7 is a diagram illustrating an example of a user information storage unit according to one embodiment.

FIG. 8 is a diagram illustrating an example of a bid information storage unit according to one embodiment.

FIG. 9 is a diagram illustrating a configuration example of a management server according to one embodiment.

FIG. 10 is a diagram illustrating an example of a clothes information storage unit according to one embodiment.

FIG. 11 is a diagram illustrating a configuration example of a business operator apparatus according to one embodiment.

FIG. 12 is a flowchart illustrating an example of information processing according to one embodiment.

FIG. 13 is a diagram illustrating an example of information processing according to a modification.

FIG. 14 is a hardware configuration diagram illustrating an example of a computer that implements functions of the information processing apparatus.

### DESCRIPTION OF EMBODIMENTS

Modes (hereinafter, referred to as “embodiments”) for carrying out an information processing apparatus, an information processing method, and an information processing program according to the present application will be described in detail below with reference to the drawings. The information processing apparatus, the information processing method, and the information processing program according to the present application are not limited by the embodiments below. In addition, in each of the embodiments below, the same components are denoted by the same reference symbols, and repeated explanation will be omitted.

### EMBODIMENT

### 1. Configuration of Information Processing System

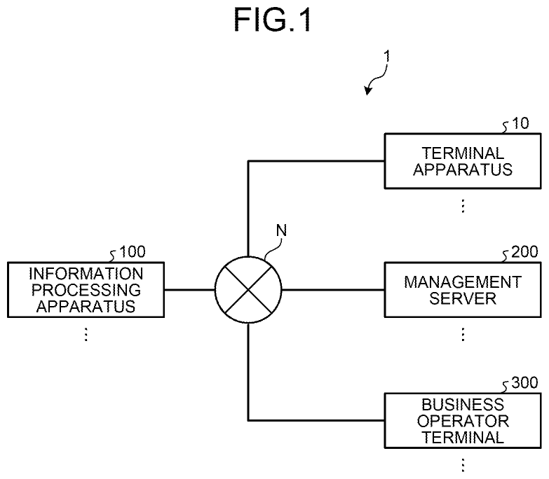

An information processing system 1 illustrated in FIG. 1 will be described. As illustrated in FIG. 1, the information processing system 1 includes a terminal apparatus 10, an information processing apparatus 100, a management server 200, and a business operator apparatus 300. The terminal apparatus 10, the information processing apparatus 100, the management server 200, and the business operator apparatus 300 are communicably connected to one another via a predetermined communication network (a network N) in a wired or wireless manner. FIG. 1 is a diagram illustrating a configuration example of the information processing system 1 according to one embodiment. Meanwhile, the information processing system 1 illustrated in FIG. 1 may include the plurality of terminal apparatuses 10, the plurality of information processing apparatuses 100, the plurality of management servers 200, and the plurality of business operator apparatuses 300.

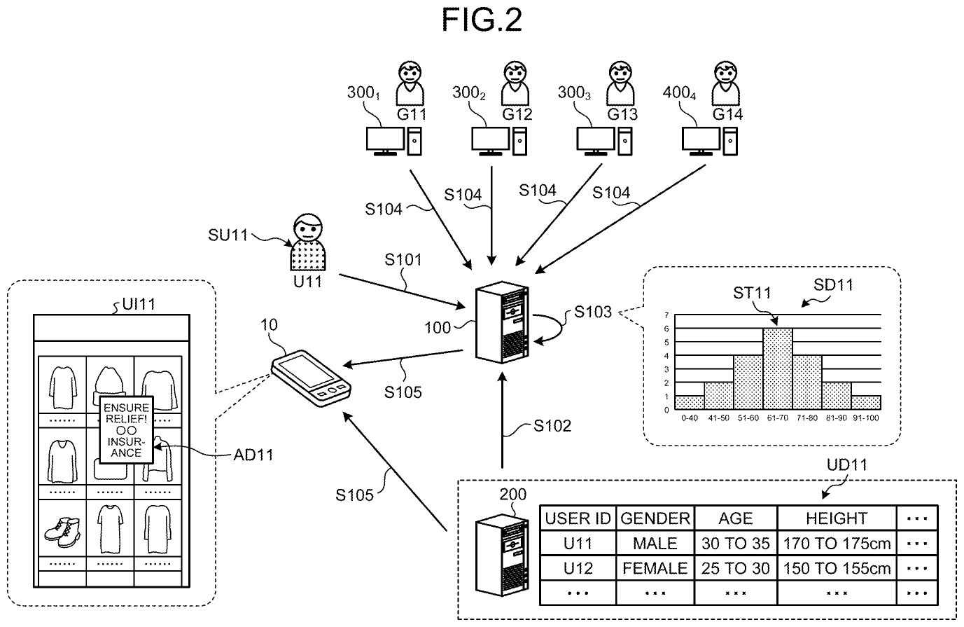

The terminal apparatus 10 is an information processing apparatus that is used by a user. The terminal apparatus 10 may be any apparatus as long as it is possible to implement processes of embodiments. Further, the terminal apparatus 10 may be any apparatus, such as a smartphone, a tablet terminal, a notebook personal computer (PC), a desktop PC, a mobile phone, or a portable digital assistant (PDA). In an example illustrated in FIG. 2, a case is illustrated in which the terminal apparatus 10 is a smartphone.

The terminal apparatus 10 is, for example, a smart device, such as a smartphone or a tablet, and is a mobile terminal apparatus that is able to perform communication with an arbitrary server apparatus via a wireless communication network, such as 3rd Generation (3G) or a Long Term Evolution (LTE). Further, the terminal apparatus 10 may include a screen, such as a liquid crystal display, with a function of a touch panel, and may receive various kinds of operation, such as tap operation, sliding operation, or scroll operation, on display data, such as contents, from a user by a finger, a stylus, or the like.

In FIG. 2, the terminal apparatus 10 is used by a user U11. In the following, the terminal apparatus 10 may be described as the user U11. In other words, in the following, the user U11 may be read as the terminal apparatus 10.

The information processing apparatus 100 is an information processing apparatus for achieving improvement in services in accordance with a body shape of the user while preventing damage of personal information, and is implemented by, for example, a server apparatus, a cloud system, or the like. For example, the information processing apparatus 100 has a function to provide information suitable for the user based on body shape information on the user and statistical data of body shape information that is based on attribute information on the user (for example, gender, an age, or a height). The information processing apparatus 100 is, for example, an information processing apparatus, such as a PC or a workstation (WS), and performs processes based on information that is transmitted from the management server 200 or the like via the network N.

The management server 200 is an information processing apparatus that manages an electronic mall, and is implemented by, for example, a server apparatus, a cloud system, or the like. For example, the management server 200 has a function to provide information (for example, an item, a size, or evaluation of a purchased product) on a purchase history of the user in the electronic mall. The management server 200 is, for example, an information processing apparatus, such as a PC or a WS, and performs processes based on information that is transmitted from the terminal apparatus 10 or the like via the network N.

The business operator apparatus 300 is an information processing apparatus that is used by a business operator who wants to provide information to a user. The business operator apparatus 300 may be any apparatus as long as it is possible to implement processes of embodiments. Further, the business operator apparatus 300 may be any apparatus, such as a smartphone, a tablet terminal, a notebook PC, a desktop PC, a mobile phone, or a PDA. In the example illustrated in FIG. 2, a case is illustrated in which the business operator apparatus 300 is a desktop PC.

In FIG. 2, a business operator apparatus 300₁ is used by a business operator G11, a business operator apparatus 300₂ is used by a business operator G12, a business operator apparatus 300₃ is used by a business operator G13, and a business operator apparatus 300₄ is used by a business operator G14. The business operator apparatuses 300₁, 300₂, 300₃ and 300₄ access the information processing apparatus 100, and transmit information received from the respective business operators to the information processing apparatus 100. Meanwhile, in the following, the business operator apparatuses 300₁, 300₂, 300₃ and 300₄ will be described as “business operator apparatuses 300” when they need not be distinguished from one another. Further, the business operators G11, G12, G13 and G14 will be simply described as “business operators” when they need not be distinguished from one another. Furthermore, in the following, the business operator apparatus 300 may be described as a business operator. In other words, in the following, the business operator may be read as the business operator apparatus 300. Meanwhile, it is assumed that, for example, the business operator G11 is an insurance company, the business operator G12 is a health food company, the business operator G13 is a pharmaceutical company, and the business operator G14 is a clothing brand company that provides clothes for users with big sizes.

Meanwhile, FIG. 1 illustrates a case in which the information processing apparatus 100 and the management server 200 are separate apparatuses, but the information processing apparatus 100 and the management server 200 may be integrated with each other.

### 2. One Example of Information Processing

In the embodiment below, for convenience of explanation, an example will be described in which an advertisement is adopted as an example of information to be provided to the user, but embodiments are not limited to this example. The information is not limited to the advertisement and any information is applicable as long as the information proposes purchase of a product or a service that can be provided by a business operator. Further, in the embodiment below, an example will be described in which clothes are adopted as an example of a target object that is provided in a predetermined electronic mall that is managed by the management server 200, but embodiments are not limited to this example. The target object is not limited to the clothes, but includes any object as long as the object is wearable by the user and a fit size of the object differs depending on the body shape of the user. Furthermore, in the embodiment below, an example will be described in which a single registered account is associated with a single user in the predetermined electronic mall that is managed by the management server 200, but embodiments are not limited to this example. Meanwhile, a process in which a plurality of users are associated with a single registered account will be described later as a modification.

FIG. 2 is a diagram illustrating an example of information processing performed by the information processing system 1 according to one embodiment. In FIG. 2, it is assumed that a proposal is given to the user U11 via the terminal apparatus 10.

The information processing apparatus 100 acquires body shape information on a body shape of the user U11 (Step S101). Meanwhile, the information processing apparatus 100 may acquire the body shape information on the user U11 by any method. FIG. 2 illustrates a case in which the information processing apparatus 100 acquires the body shape information on the user U11 via clothes SU11 capable of measuring details of the body shape information by being worn, but embodiments are not limited to this example. For example, the information processing apparatus 100 may acquire the body shape information on the user U11 based on registration (input) performed by the user U11. Further, for example, the information processing apparatus 100 may acquire the body shape information on the user U11 by estimation based on predetermined information (for example, a purchase history, a search history, or a browsing history) on the user U11. Meanwhile, the body shape information acquired by the information processing apparatus 100 is not limited to information on a specific body size, such as an abdominal circumference, an arm circumference, or a thigh, but may include information on a height, a weight, or the like.

The information processing apparatus 100 acquires pieces of body shape information on a plurality of users based on attribute information on the user U11 (Step S102). For example, when the attribute information on the user U11 includes “gender: male, age: 30 to 35, height: 170 to 175 centimeters (cm)”, the information processing apparatus 100 acquires pieces of body shape information on a plurality of users including the same attribute information and performs statistical analysis. In this manner, the information processing apparatus 100 acquires statistical data of the body shape information based on the attribute information on the user U11. In FIG. 2, the information processing apparatus 100 acquires statistical data SD11. Meanwhile, FIG. 2 illustrates a case in which the pieces of body shape information on the plurality of users based on the attribute information on the user U11 are acquired from the management server 200, but embodiments are not limited to this example, and the pieces of body shape information may be acquired in any method. Further, if the pieces of body shape information on the plurality of users based on the attribute information on the user U11 are not acquired from the management server 200, the attribute information on the user U11 may be acquired from, for example, the management server 200. For example, the attribute information on the user U11 may be acquired from attribute data UD11. In this manner, the attribute information on the user U11 may be identified based on registration information that is registered by the user U11 in the predetermined electronic mall. Furthermore, the pieces of body shape information on the plurality of users based on the attribute information on the user U11 may be acquired from, for example, a storage unit of the information processing apparatus 100.

The statistical data SD11 will be described below. The statistical data SD11 is statistical data that is related to weights of users with the same attribute information of “gender: male, age: 30 to 35, height: 170 to 175 cm” as the user U11. A horizontal axis of the statistical data SD11 is an axis that represents a weight, and a vertical axis is an axis that represents the number of persons. For example, the statistical data SD11 indicates that the number of users with the weight of “61 to 70 kilograms (kg)” is six, which is maximum. Therefore, in the statistical data SD11, a user with the weight of “61 to 70 kg” is a user with the most standard body shape information with respect to the attribute information on the user U11. Meanwhile, in the following, a body shape of the user with the standard body shape information as described above will be appropriately referred to as a standard body shape based on the statistical data. The information processing apparatus 100 identifies a standard body shape ST11 based on the statistical data SD11. Meanwhile, for convenience of explanation, FIG. 2 illustrates a case in which the statistical data SD11 is statistical data related to weights, but embodiments are not limited to this example, and, for example, the statistical data may be related to a specific body size, such as an abdominal circumference, an arm circumference, or a thigh, or related to a total score that is obtained by scoring body shape information on each of the abdominal circumference, the arm circumference, the thigh, and the like and adding up the scores. Meanwhile, the statistical data SD11 is not limited to data based on a histogram as illustrated in FIG. 2, but may be any kind of statistical data.

The information processing apparatus 100 compares the body shape information on the user U11 and the body shape information on the standard body shape ST11, and calculates a difference between the body shape of the user U11 and the standard body shape ST11 (Step S103). For example, if the weight of the user U11 is 80 kg, the information processing apparatus 100 performs comparison with the standard body shape ST11 of “61 to 70 kg” and calculates a difference of 10 to 20 kg. The information processing apparatus 100 calculates that the body shape of the user U11 is a body shape that is heavier by about 10 to 20 kg than the standard body shape ST11 based on the difference. Accordingly, the user U11 is able to appropriately and statistically recognize a level of the body shape information on the user U11. Meanwhile, the information processing apparatus 100 may determine comparison with the standard body shape ST11 based on whether the difference is equal to or larger than a predetermined threshold. For example, if the weight of the user U11 is 72 kg and the predetermined threshold is 15 kg, the information processing apparatus 100 may determine that there is no difference from the standard body shape ST11.

Subsequently, the information processing apparatus 100 acquires body shape information on a target user who is determined in advance as a user to whom the business operator wants to provide an advertisement (Step S104). In FIG. 2, the information processing apparatus 100 acquires body shape information on a target user for each of the business operators (G11 to G14). The target user will be described below.

The target user is, for example, a user who has target attribute information of the business operator and has a certain body shape that is calculated such that a difference from a standard body shape that is identified based on the attribute information falls within a predetermined range (for example, equal to or larger than a predetermined threshold or smaller than the predetermined threshold). In the following, for convenience of explanation, explanation will be given based on the assumption that target attribute information of the business operators G11 to G14 commonly includes attribute information on the user U11, that is, “gender: male, age: 30 to 35, height: 170 to 175 centimeters (cm)”.

It is assumed that the business operators G11 to G14 make bids for an advertisement space such that an advertisement of each of the business operators is preferentially provided on a web service that provides the predetermined electronic mall that is managed by the management server 200. It is assumed that the business operator G11 makes a bid for providing an advertisement for, for example, a relatively expensive insurance that the business operator G11 can provide to a user for whom a difference from the standard body shape is equal to or larger than 10 kilograms (kg), as compared to a user for whom the difference is smaller than 10 kg. Further, it is assumed that the business operator G12 makes a bid for providing an advertisement for, for example, healthy food that the business operator G12 can provide to a user for whom the difference from the standard body shape is equal to or lager than 8 kg. Furthermore, it is assumed that the business operator G13 makes a bid for providing an advertisement for, for example, supplement or medicine that the business operator G13 can provide to a user for whom the difference from the standard body shape is equal to or larger than 5 kg. Moreover, it is assumed that the business operator G14 makes a bid for providing an advertisement for, for example, clothes for users with big sizes that the business operator G13 can provide to a user for whom the difference from the standard body shape is equal to or larger than 10 kg. Meanwhile, it is assumed bid prices of the business operators G11, G12, G13 and G14 are higher in this order. Furthermore, explanation will be given below based on the assumption that the body shape information on the user U11 meets all of predetermined thresholds for providing the advertisements of all of the business operators G11 to G14. Meanwhile, in FIG. 2, a case is illustrated in which four business operators such as the business operators G11 to G14 make bids, but the number of the business operators who make bids is not specifically limited.

The information processing apparatus 100 provides information on an advertisement that is suitable for the user U11 in accordance with the difference from the standard body shape ST11. Specifically, the information processing apparatus 100 provides the information on the advertisement that is suitable for the user U11 in accordance with the difference from the standard body shape ST11 from among the advertisements of the business operators G11 to G14 for which the body shape information on the user U11 is included in the body shape information on the target user. In FIG. 2, the bid price of the business operator G11 is the highest, and therefore, the information processing apparatus 100 provides information on the advertisement of the business operator G11. Meanwhile, the advertisement may be provided to the user U11 by the information processing apparatus 100 or by the management server 200. Further, when the management server 200 provides an advertisement, the information processing apparatus 100 provides the information on the advertisement that is suitable for the user U11 to the management server 200. Meanwhile, the predetermined threshold for determining the difference may be freely set by each of the business operators, and therefore, a timing to provide the advertisement is freely set by each of the business operators.

A screen UI11 is one example of a UI screen for providing an advertisement that is suitable for the user U11. The screen UI11 is, for example, contents of a web service that provides the predetermined electronic mall that is managed by the management server 200. The screen UI11 is displayed based on information that is provided by the management server 200. Further, the screen UI11 includes an advertisement space AD11 for displaying the advertisement that is suitable for the user U11 in a predetermined area. The advertisement that is displayed in the advertisement space AD11 is displayed based on information that is provided by the information processing apparatus 100. In FIG. 2, an advertisement related to an insurance of the business operator G11 is displayed in the advertisement space AD11.

The information processing apparatus 100 may provide, for example, information on a relatively cheap insurance to a user with the standard body shape based on the attribute information, and may provide information on a relatively expensive insurance to a user who is far from the standard body shape. In this manner, the information processing apparatus 100 may change the information to be provided based on a degree of difference of the body shape from a median value with reference to the body shape information. With this configuration, the information processing apparatus 100 is able to provide an arbitrary advertisement with respect to body shape information on an arbitrary user.

The screen UI11 may display a display space for displaying information for providing approach to the standard body shape ST11, although not illustrated in the drawings. For example, the screen UI11 may include a display space for displaying a proposal of “this level of body shape is recommended based on your information” as one example of the information for proposing approach to the standard body shape ST11. In this display space, it may be possible to display information on the standard body shape ST11, such as “standard weight is 61 to 70 kg”, or information on the difference from the body shape information on the standard body shape ST11, such as “your weight is heavier by 10 kg, so let's lose 10 kg”. With this configuration, the information processing apparatus 100 is able to promote health maintenance of the user U11 even from the viewpoint of healthcare.

The screen UI11 may include a display space for displaying information on clothes that fit the current body shape of the user U11 and that are available for purchase in the predetermined electronic mall that is managed by the management server 200, although not illustrated in the drawings. For example, it may be possible to display a proposal of “following clothes are recommended as clothes that fit your current body shape”, as one example of the information for proposing clothes that fit the current body shape of the user U11. Similarly, the screen UI11 may include a display space for displaying information on clothes that fit the standard body shape ST11 and that are available for purchase in the predetermined electronic mall that is managed by the management server 200. For example, it may be possible to display a proposal of “celebrity ∘∘A has worn clothes ∘∘B, but your body shape is ∘∘C, so how about losing weight?” as one example of the information for proposing clothes that fit the standard body shape ST11. With this configuration, the information processing apparatus 100 is able to clarify a worn image of the clothes that fit, so that it is possible to promote increase in motivation in approaching the standard body shape. Further, with this configuration, the information processing apparatus 100 is able to promote increase in motivation in approaching the standard body shape, so that it is possible to promote increase in revenue and profit due to proposal of purchase of the clothes. Meanwhile, it may be possible to preferentially display clothes that fit a predetermined body shape at the time of search in the predetermined electronic mall, instead of displaying the clothes in the display space.

Meanwhile, in the embodiment as described above, the case has been described in which each of the business operators G11 to G14 sets the threshold for the difference to determine a target user to which the advertisement is to be provided when making a bid for the advertisement space, but embodiments are not limited to this example. For example, the business operators G11 to G14 may make bids with respect to a threshold for the difference that is determined in advance. In this case, for example, the information processing apparatus 100 may separately store bid information for providing an advertisement when the difference is equal to or larger than the threshold for the difference that is determined in advance and information for providing an advertisement when the difference is smaller than the threshold for the difference that is determined in advance, and may provide an advertisement based on one of the pieces of bid information based on the body shape information on a subject user.

Meanwhile, in the embodiment as described above, the information processing apparatus 100 may perform a process of setting a target body shape as a goal to be achieved by the user U11 and giving a privilege (for example, a point) that is available in the predetermined electronic mall that is managed by the management server 200 when the user U11 approaches the target body shape. For example, the information processing apparatus 100 may give preferential treatment, such as increase in the privilege to be given, with approach to the target body shape. In this manner, the information processing apparatus 100 may provide information on the privilege that is increased with approach to the target body shape. Further, the information processing apparatus 100 may identify a degree to which the user U11 has approached the target body shape and provide information on the identified degree to the management server 200, and, the management server 200 may perform a process of giving a privilege. Furthermore, the information processing apparatus 100 may regularly or irregularly give preferential treatment, such as an increase in the privilege to be given, with respect to a user who has registered the body shape information. With this configuration, the information processing apparatus 100 is able to appropriately manage the body shape information on the user, so that it is possible to promote improvement in services in accordance with the body shape of the user.

Meanwhile, in the embodiment as described above, the information processing apparatus 100 may dynamically change the advertisement to be provided in accordance with a change in the body shape or a purchase history of the user U11. For example, the information processing apparatus 100 may determine a change in the body shape or the purchase history of the user U11, and if it is determined that the change is equal to or larger than a predetermined threshold, it may be possible to dynamically change the advertisement to be provided in the screen UI11 in accordance with the change of the body shape or the purchase history of the user U11. With this configuration, the information processing apparatus 100 is able to allow the business operator side to dynamically perform targeting to provide an advertisement without providing personal information on the user U11 to the business operator side.

Meanwhile, in the embodiment as described above, the information processing apparatus 100 need not always be applied to services for proposing clothes that are available for purchase in an electronic mall, but may be applied to services for proposing other clothes, such as used clothes, for example.

### 3. Configuration of Terminal Apparatus

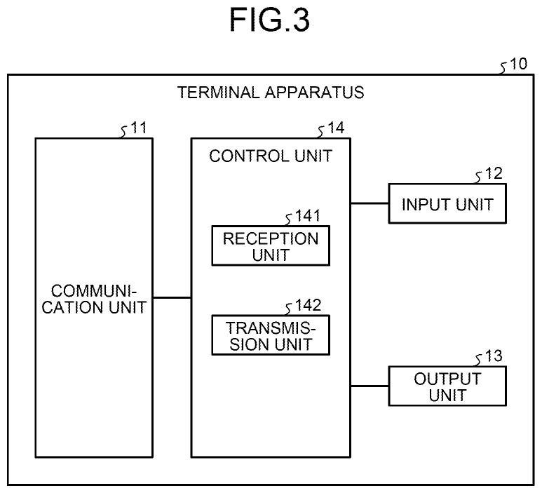

A configuration of the terminal apparatus 10 according to one embodiment will be described below with reference to FIG. 3. FIG. 3 is a diagram illustrating a configuration example of the terminal apparatus 10 according to one embodiment. As illustrated in FIG. 3, the terminal apparatus 10 includes a communication unit 11, an input unit 12, an output unit 13, and a control unit 14.

### Communication Unit 11

The communication unit 11 is implemented by, for example, a Network Interface Card (NIC) or the like. Further, the communication unit 11 is connected to the predetermined network N in a wired or wireless manner, and transmits and receives information to and from the information processing apparatus 100 or the like via the predetermined network N.

### Input Unit 12

The input unit 12 receives various kinds of operation from a user. In the example illustrated in FIG. 2, various kinds of operation from the user U11 are received. For example, the input unit 12 may receive various kinds of operation from the user via a display screen by a touch-panel function. Further, the input unit 12 may receive various kinds of operation from a button that is arranged in the terminal apparatus 10 or a keyboard or a mouse that is connected to the terminal apparatus 10.

### Output Unit 13

The output unit 13 is a display screen of a tablet terminal or the like that is implemented by, for example, a liquid crystal display, an organic Electro-Luminescence (EL) display, or the like, and is a display apparatus for displaying various kinds of information. For example, the output unit 13 displays information that is transmitted from the information processing apparatus 100.

### Control Unit 14

The control unit 14 is, for example, a controller, and is implemented by causing a Central Processing Unit (CPU), a Micro Processing Unit (MPU), or the like to execute various kinds of programs that are stored in an internal storage apparatus of the terminal apparatus 10 while using a Random Access Memory (RAM) as a work area. For example, the various kinds of programs include a program of an application that is installed in the terminal apparatus 10. For example, the various kinds of programs include a program of an application that displays information transmitted from the information processing apparatus 100. Further, the control unit 14 is implemented by, for example, an integrated circuit, such as an Application Specific Integrated Circuit (ASIC) or a Field Programmable Gate Array (FPGA).

As illustrated in FIG. 3, the control unit 14 includes a reception unit 141 and a transmission unit 142, and implements or executes operation of information processing as described below.

### Reception Unit 141

The reception unit 141 receives various kinds of information. The reception unit 141 receives various kinds of information from an external information processing apparatus. The reception unit 141 receives various kinds of information from a different information processing apparatus, such as the information processing apparatus 100. For example, the reception unit 141 receives contents of a web service that provides predetermined electronic commerce. Further, for example, the reception unit 141 receives information on an advertisement to be displayed on the contents of the web service that provides the predetermined electronic commerce.

### Transmission Unit 142

The transmission unit 142 transmits various kinds of information to an external information processing apparatus. The transmission unit 142 transmits various kinds of information to a different information processing apparatus, such as the information processing apparatus 100. For example, the transmission unit 142 transmits the body shape information that is input by the user.

### 4. Configuration of Information Processing Apparatus

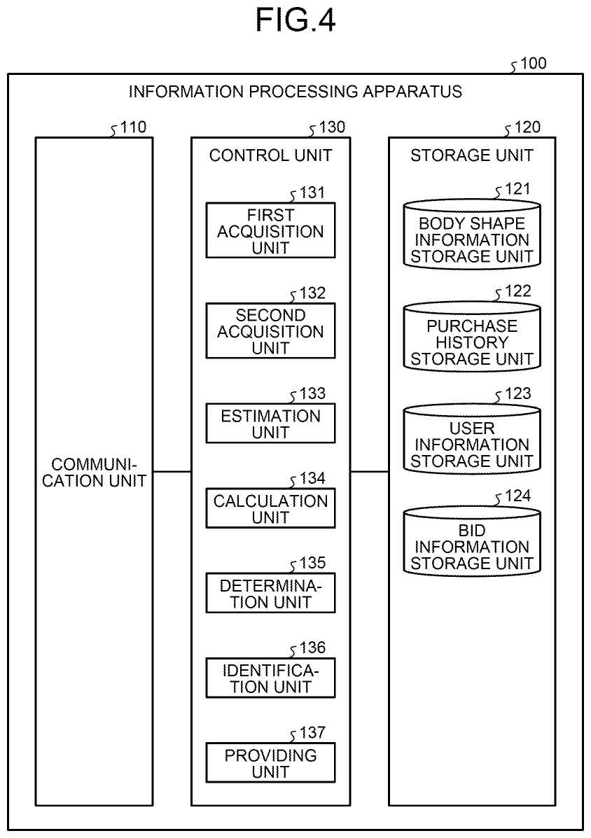

A configuration of the information processing apparatus 100 according to one embodiment will be described below with reference to FIG. 4. FIG. 4 is a diagram illustrating a configuration example of the information processing apparatus 100 according to one embodiment. As illustrated in FIG. 4, the information processing apparatus 100 includes a communication unit 110, a storage unit 120, and a control unit 130. Meanwhile, the information processing apparatus 100 may include an input unit (for example, a keyboard, a mouse, or the like) that receives various kinds of operation from an administrator of the information processing apparatus 100, or a display unit (for example, a liquid crystal display or the like) for displaying various kinds of information.

### Communication Unit 110

The communication unit 110 is implemented by, for example, a NIC or the like. Further, the communication unit 110 is connected to the network N in a wired or wireless manner, and transmits and receives information to and from the terminal apparatus 10 or the like via the network N.

### Storage Unit 120

The storage unit 120 is implemented by, for example, a semiconductor memory device, such as a RAM or a flash memory, or a storage device, such as a hard disk or an optical disk. As illustrated in FIG. 4, the storage unit 120 includes a body shape information storage unit 121, a purchase history storage unit 122, a user information storage unit 123, and a bid information storage unit 124.

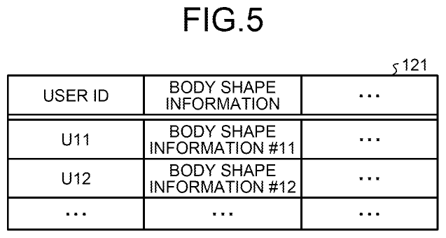

The body shape information storage unit 121 stores therein the body shape information on the user. Here, FIG. 5 illustrates an example of the body shape information storage unit 121 according to one embodiment. As illustrated in FIG. 5, the body shape information storage unit 121 includes items, such as a “user ID” and “body shape information”.

The “user ID” indicates identification information for identifying a user. The “body shape information” indicates the body shape information. In the example illustrated in FIG. 5, the example is illustrated in which conceptual information, such as “body shape information #11” or “body shape information #12”, is stored in the “body shape information”, but in reality, a measurement value of an abdominal circumference, an arm circumference, or a thigh is stored.

Specifically, FIG. 5 illustrates the example in which the body shape information on the user who is identified by a user ID of “U11” is the “body shape information #11”.

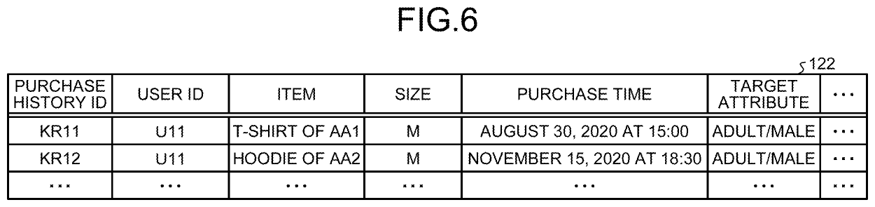

The purchase history storage unit 122 stores therein information on the purchase history of the user. For example, the purchase history storage unit 122 stores therein information on a purchase history about a purchase that is performed in a predetermined electronic mall that is managed by the management server 200. Here, FIG. 6 illustrates an example of the purchase history storage unit 122 according to one embodiment. As illustrated in FIG. 6, the purchase history storage unit 122 includes items, such as a “purchase history ID”, a “user ID”, an “item”, a “size”, a “purchase time”, and a “target attribute”.

The “purchase history ID” indicates identification information for identifying a purchase history. The “user ID” indicates identification information for identifying a user. The “item” indicates an item of a purchased product. The “purchase time” indicates a time when the purchased product is purchased. The “target attribute” indicates an attribute of a target user of the purchased product.

Specifically, FIG. 6 illustrates an example in which a user who has made a purchase that is identified by a purchase history ID of “KR11” is identified by “U11”, an item of the purchased product is a “T-shirt of AA1”, a size is “M”, a purchase time is “Aug. 30, 2020 at 15:00”, and a target attribute is “adult male”.

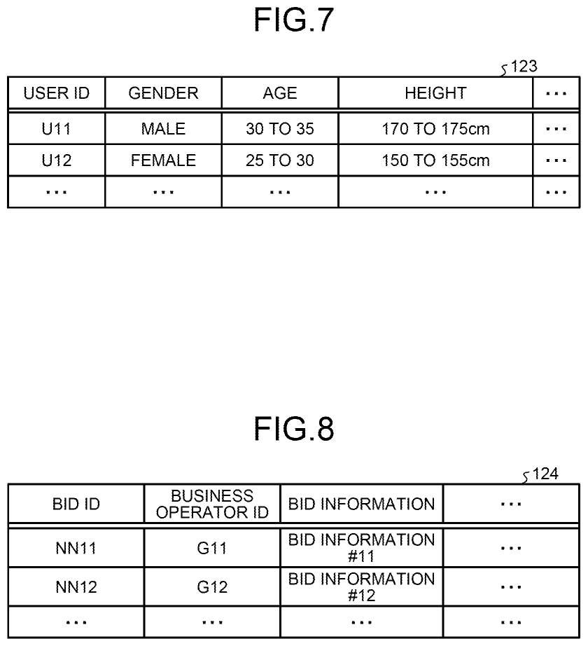

The user information storage unit 123 stores therein user information. For example, the user information storage unit 123 stores therein the attribute information on the user. Here, FIG. 7 illustrates an example of the user information storage unit 123 according to one embodiment. As illustrated in FIG. 7, the user information storage unit 123 includes items, such as a “user ID”, “gender”, an “age”, and a “height”.

The “user ID” indicates identification information for identifying a user. The “gender” indicates gender of the user. The “age” indicates an age of the user. The “height” indicates a height of the user.

Specifically, FIG. 7 illustrates an example in which a user who is identified by a user ID of “U11” is a user with gender of “male”, an age of “30 to 35 years old”, and a height of “170 to 175 cm”.

The bid information storage unit 124 stores therein bid information on a business operator. Here, FIG. 8 illustrates an example of the bid information storage unit 124 according to one embodiment. As illustrated in FIG. 8, the bid information storage unit 124 includes items, such as a “bid ID”, a “business operator ID”, and “bid information”.

The “bid ID” indicates identification information for identifying a bid. The “business operator ID” indicates identification information for identifying a business operator. The “bid information” indicates bid information. In the example illustrated in FIG. 8, an example is illustrated in which conceptual information, such as “bid information #11” or “bid information #12”, is stored in the “bid information”, but in reality, combination information of a bid price for an advertisement space, information on the body shape information on the target user, and information on an advertisement, or the like is stored.

Specifically, FIG. 8 illustrates an example in which a business operator who has made a bid that is identified by a bid ID of “NN11” is identified by “G11” and the bid information is the “bid information #11”.

### Control Unit 130

The control unit 130 is a controller and is implemented by, for example, causing a CPU, an MPU, or the like to execute various kinds of programs that are stored in an internal storage apparatus of the information processing apparatus 100 while using a RAM as a work area. Further, the control unit 130 is a controller and is implemented by, for example, an integrated circuit, such as an ASIC or an FPGA.

As illustrated in FIG. 4, the control unit 130 includes a first acquisition unit 131, a second acquisition unit 132, an estimation unit 133, a calculation unit 134, a determination unit 135, an identification unit 136, and a providing unit 137, and implements or executes operation of information processing as described below. Meanwhile, an internal configuration of the control unit 130 is not limited to the configuration as illustrated in FIG. 4, and any configuration is applicable as long as the information processing to be described later is performed.

### First Acquisition Unit 131

The first acquisition unit 131 acquires various kinds of information. The first acquisition unit 131 acquires various kinds of information from an external information processing apparatus. The first acquisition unit 131 acquires various kinds of information from a different information processing apparatus, such as the management server 200.

The first acquisition unit 131 acquires various kinds of information from the storage unit 120. The first acquisition unit 131 acquires various kinds of information from the body shape information storage unit 121, the purchase history storage unit 122, the user information storage unit 123, or the bid information storage unit 124. Further, the first acquisition unit 131 stores various kinds of acquired information in the storage unit 120. The first acquisition unit 131 stores various kinds of information in the body shape information storage unit 121, the purchase history storage unit 122, the user information storage unit 123, or the bid information storage unit 124.

The first acquisition unit 131 acquires the body shape information on the user. For example, the first acquisition unit 131 acquires the body shape information that is measured by a body shape information measurement means that is able to measure details of the body shape information.

The first acquisition unit 131 acquires information on the purchase history of the user. For example, the first acquisition unit 131 acquires information on a purchase history about a purchase that is performed in the predetermined electronic mall.

The first acquisition unit 131 acquires user information on a user. For example, the first acquisition unit 131 acquires attribute information that is registered in the predetermined electronic mall.

The first acquisition unit 131, when a plurality of users are associated with a single account, acquires the body shape information or the user information for each of the users who are associated with the single account. Further, the first acquisition unit 131 may acquire information on purchase histories for the plurality of users who are associated with the single account. In other words, the first acquisition unit 131 may acquire information on the purchase history of a purchase that is performed by one of the users, for each of the users.

### Second Acquisition Unit 132

The second acquisition unit 132 acquires the bid information. For example, the second acquisition unit 132 acquires bid information on a bid that is made by a business operator for an advertisement space in order to provide an advertisement on a web service that provides a predetermined electronic mall. Further, the second acquisition unit 132 acquires information on the body shape information on a target user to whom the business operator wants to provide the advertisement, together with the bid information.

### Estimation Unit 133

The estimation unit 133 estimates a change of a body shape of a user. For example, the estimation unit 133 estimates a change of the body shape of the user based on the information on a change of the purchase history. For example, if the size of the clothes purchased by the user is changed from M to L, the estimation unit 133 estimates that the body shape of the user is increased. Further, for example, the estimation unit 133 estimates that the body shape of the user is increased with the age of the user based on the attribute information on the user.

The estimation unit 133, when a plurality of users are associated with a single account, may estimate attribute information for each of the users. Further, the estimation unit 133 may estimate a relationship, such as a family structure, of the plurality of users based on the estimation result.

### Calculation Unit 134

The calculation unit 134 calculates a difference between the body shape of the user and a standard body shape based on the body shape information on the user and statistical data of body shape information that is based on the attribute information on the user. For example, if the weight of the user is 80 kg and the weight of the standard body shape is 70 kg, the calculation unit 134 calculates that a difference is 10 kg.

### Determination Unit 135

The determination unit 135 determines a change of the body shape or the purchase history of the user. Further, the determination unit 135 determines that the advertisement provided to the user is dynamically changed in accordance with a change of the body shape or the purchase history of the user. For example, when the body shape of the user is changed from M to XXL, the determination unit 135 determines that the advertisement to be provided is changed from an advertisement for a relatively cheap insurance to an advertisement for a relatively expensive insurance.

The determination unit 135 compares the body shape information on the user and the body shape information on the standard body shape, and determines whether a difference calculated by the calculation unit 134 is equal to or larger than a predetermined threshold. Further, if it is determined that the difference is equal to or larger than the predetermined threshold, the determination unit 135 determines that an advertisement suitable for the body shape of the user is to be given. For example, if it is determined that the difference is equal to or larger than the predetermined threshold, the determination unit 135 may determine the advertisement to be provided from among advertisements that are classified in advance based on magnitudes of differences with respect to the predetermined threshold. In this case, for example, the advertisement to be provided may be determined based on the bid information. Further, the determination unit 135 may determine the magnitude of the difference by comparison with a threshold that is determined in advance for each of the business operators. Furthermore, if it is determined that the difference is equal to or larger than the predetermined threshold, the determination unit 135 may determine that information for proposing approach to the standard body shape is to be given.

The determination unit 135 may determine whether a plurality of users are associated with a single account. Further, if the plurality of users are associated with a single account, the determination unit 135 may perform determination for each of the users.

### Identification Unit 136

The identification unit 136 identifies an advertisement to be provided to a user. For example, the identification unit 136 identifies an advertisement that is suitable for a current body shape of the user. For example, the identification unit 136 identifies the advertisement that is suitable for the current body shape of the user based on the determination result obtained by the determination unit 135 and the bid information.

The identification unit 136 identifies clothes or services that fit the current body shape of the user. Further, the identification unit 136 identifies clothes or services that fit the standard body shape or a target body shape.

The identification unit 136, when a plurality of users are associated with a single account, may identify a user who is to be subjected to determination performed by the determination unit 135 among the plurality of users. For example, the identification unit 136 may identify a single user who is to be subjected to determination performed by the determination unit 135 based on the body shape information associated with the single account, information on the purchase history, or the user information.

### Providing Unit 137

The providing unit 137 provides information on the advertisement that is identified by the identification unit 136 in accordance with the difference calculated by the calculation unit 134. For example, the providing unit 137 provides information on the advertisement that is suitable for a body shape of a subject user from among advertisements of a business operator for which the body shape information on the subject user is included in the body shape information on the target user.

The providing unit 137 provides information for proposing approach to the standard body shape in accordance with the difference calculated by the calculation unit 134.

### 5. Configuration of Management Server

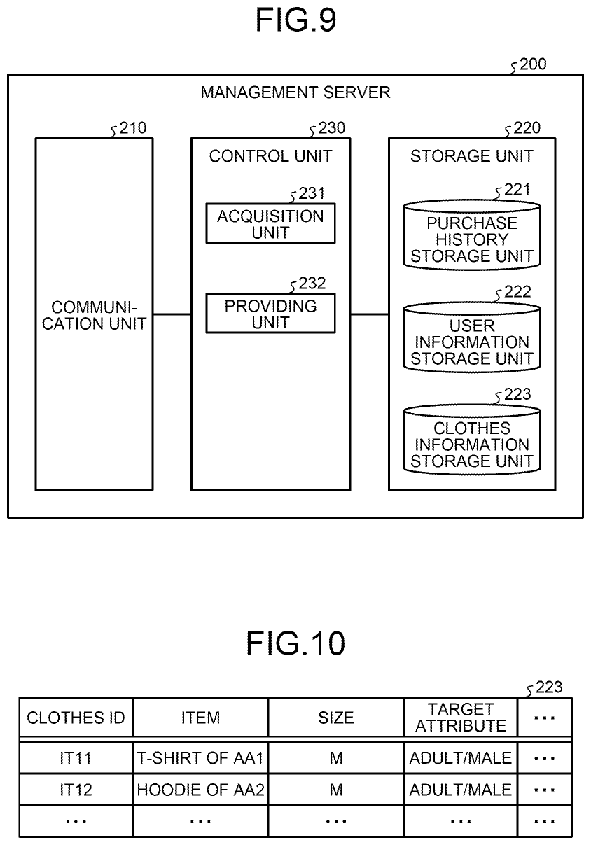

A configuration of the management server 200 according to one embodiment will be described below with reference to FIG. 9. FIG. 9 is a diagram illustrating a configuration example of the management server 200 according to one embodiment. As illustrated in FIG. 9, the management server 200 includes a communication unit 210, a storage unit 220, and a control unit 230. Meanwhile, the management server 200 may include an input unit (for example, a keyboard, a mouse, or the like) that receives various kinds of operation from an administrator of the management server 200, or a display unit (for example, a liquid crystal display or the like) for displaying various kinds of information.

### Communication Unit 210

The communication unit 210 is implemented by, for example, a NIC or the like. Further, the communication unit 210 is connected to the network N in a wired or wireless manner, and transmits and receives information to and from the information processing apparatus 100 or the like via the network N.

### Storage Unit 220

The storage unit 220 is implemented by, for example, a semiconductor memory device, such as a RAM or a flash memory, or a storage device, such as a hard disk or an optical disk. As illustrated in FIG. 9, the storage unit 120 includes a purchase history storage unit 221, a user information storage unit 222, and a clothes information storage unit 223.

The purchase history storage unit 22 stores therein the same information as the purchase history storage unit 122. Therefore, detailed explanation will be omitted.

The user information storage unit 222 stores therein the same information as the user information storage unit 123. Therefore, detailed explanation will be omitted.

The clothes information storage unit 223 stores therein clothes information. For example, the clothes information storage unit 223 stores therein information on clothes that are available for purchase in the predetermined electronic mall that is managed by the management server 200. Here, FIG. 10 illustrates an example of the clothes information storage unit 223 according to one embodiment. As illustrated in FIG. 10, the clothes information storage unit 223 includes items, such as a “clothes ID”, an “item”, a “size”, and a “target attribute”.

The “clothes ID” indicates identification information for identifying clothes. The “item” indicates an item of the clothes. The “size” indicates a size of the clothes. The “target attribute” indicates an attribute of a target user of the clothes.

Specifically, FIG. 10 illustrates an example in which an item of clothes identified by a clothes ID of “IT11” is a “T-shirt of AA1”, a size is “M”, and a target attribute is “adult male”.

### Control Unit 230

The control unit 230 is a controller and is implemented by, for example, causing a CPU, an MPU, or the like to execute various kinds of programs that are stored in an internal storage apparatus of the management server 200 while using a RAM as a work area. Further, the control unit 230 is a controller and is implemented by, for example, an integrated circuit, such as an ASIC or an FPGA.

As illustrated in FIG. 9, the control unit 230 includes an acquisition unit 231 and a providing unit 232, and implements or executes operation of information processing as described below. Meanwhile, an internal configuration of the control unit 230 is not limited to the configuration as illustrated in FIG. 9, and any configuration is applicable as long as the information processing to be described later is performed.

### Acquisition Unit 231

The acquisition unit 231 acquires information on the purchase history of the user. Further, the acquisition unit 231 acquires the user information. Furthermore, the acquisition unit 231 acquires the clothes information.

### Providing Unit 232

The providing unit 232 provides the information on the purchase history of the user. Further, the providing unit 232 provides the user information. Furthermore, the providing unit 232 provides the clothes information.

### 6. Configuration of Business Operator Apparatus

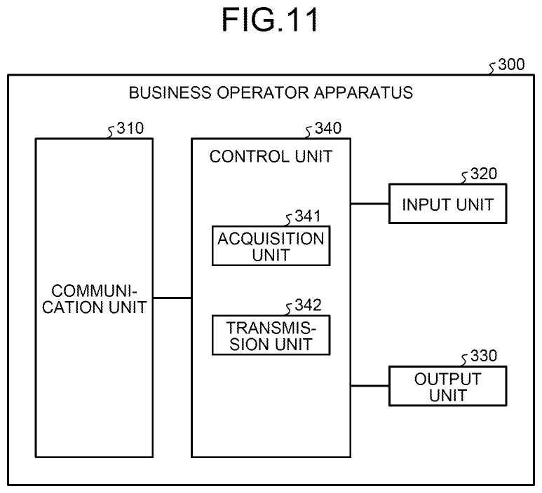

A configuration of the business operator apparatus 300 according to one embodiment will be described below with reference to FIG. 11. FIG. 11 is a diagram illustrating a configuration example of the business operator apparatus 300 according to one embodiment. As illustrated in FIG. 11, the business operator apparatus 300 includes a communication unit 310, an input unit 320, an output unit 330, and a control unit 340.

### Communication Unit 310

The communication unit 310 is implemented by, for example, a NIC or the like. Further, the communication unit 310 is connected to the network N in a wired or wireless manner, and transmits and receives information to and from the information processing apparatus 100 or the like via the network N.

### Input Unit 320

The input unit 320 receives various kinds of operation from a business operator. In the example illustrated in FIG. 11, various kinds of operation from the business operators G11 to G14 are received. For example, the input unit 320 may receive various kinds of operation from the business operator via a display screen by a touch-panel function. Further, the input unit 320 may receive various kinds of operation from a button that is arranged in the business operator apparatus 300 or a keyboard or a mouse that is connected to the business operator apparatus 300.

### Output Unit 330

The output unit 330 is a display screen of a tablet terminal or the like that is implemented by, for example, a liquid crystal display, an organic EL display, or the like, and is a display apparatus for displaying various kinds of information. For example, the output unit 330 displays information that is transmitted from the information processing apparatus 100.

### Control Unit 340

The control unit 340 is, for example, a controller, and is implemented by causing a CPU, an MPU, or the like to execute various kinds of programs that are stored in an internal storage apparatus of the business operator apparatus 300 while using a RAM as a work area. For example, the various kinds of programs include a program of an application that is installed in the business operator apparatus 300. For example, the various kinds of programs include a program of an application that transmits the information received from the business operators to the information processing apparatus 100. Further, the control unit 340 is implemented by, for example, an integrated circuit, such as an ASIC or an FPGA.

As illustrated in FIG. 11, the control unit 340 includes an acquisition unit 341 and a transmission unit 342, and implements or executes operation of information processing as described below.

### Acquisition Unit 341

The acquisition unit 341 acquires various kinds of information received from a business operator. For example, the acquisition unit 341 acquires bid information that is received from a business operator for an advertisement space for providing an advertisement on contents of a web service that provides predetermined electronic commerce.

### Transmission Unit 342

The transmission unit 342 transmits information that is acquired by the acquisition unit 341.

### 7. Flow of Information Processing

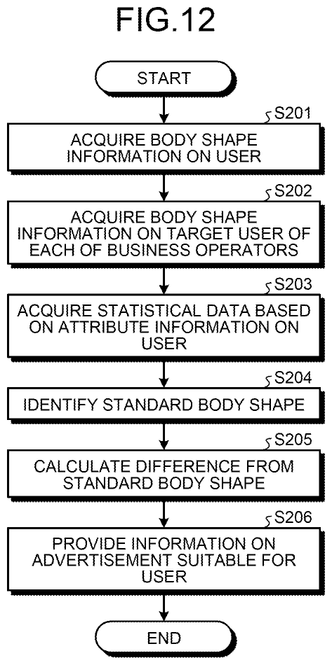

The flow of information processing performed by the information processing system 1 according to one embodiment will be described below with reference to FIG. 12. FIG. 12 is a flowchart illustrating the flow of the information processing performed by the information processing system 1 according to one embodiment.

As illustrated in FIG. 12, the information processing apparatus 100 acquires the body shape information on the user (Step S201).

The information processing apparatus 100 acquires the body shape information on a target user of each of the business operators (Step S202).

The information processing apparatus 100 acquires the statistical data of the body shape information based on the attribute information on the user (Step S203).

The information processing apparatus 100 identifies a standard body shape based on the acquired statistical data (Step S204).

The information processing apparatus 100 calculates a difference from the identified standard body shape based on the acquired body shape information on the user (Step S205).

The information processing apparatus 100 provides information on an advertisement that is suitable for the user from among advertisements of a business operator for which the body shape information on the target user includes the body shape information on the user in accordance with the calculated difference (Step S206).

### 8. Modification

The information processing system 1 according to one embodiment as described above may be embodied in various different forms other than the embodiment as described above. Therefore, other embodiments of the information processing system 1 will be described below.

Case in which Plurality of Users are Associated with Single Account

In the embodiment as described above, the example has been explained in which a single user is associated with a single registered account in the predetermined electronic mall that is managed by the management server 200, but embodiments are not limited to this example. Specifically, in the embodiment as described above, a plurality of users may be associated with a single registered account. For example, when the user has a family, there may be a case in which the user may get insurance for the family (for example, a spouse of the user or the like). A process that is performed when a plurality of users are associated with a single registered account in the predetermined electronic mall that is managed by the management server 200 will be described below. Meanwhile, the same explanation as FIG. 2 will be appropriately omitted.

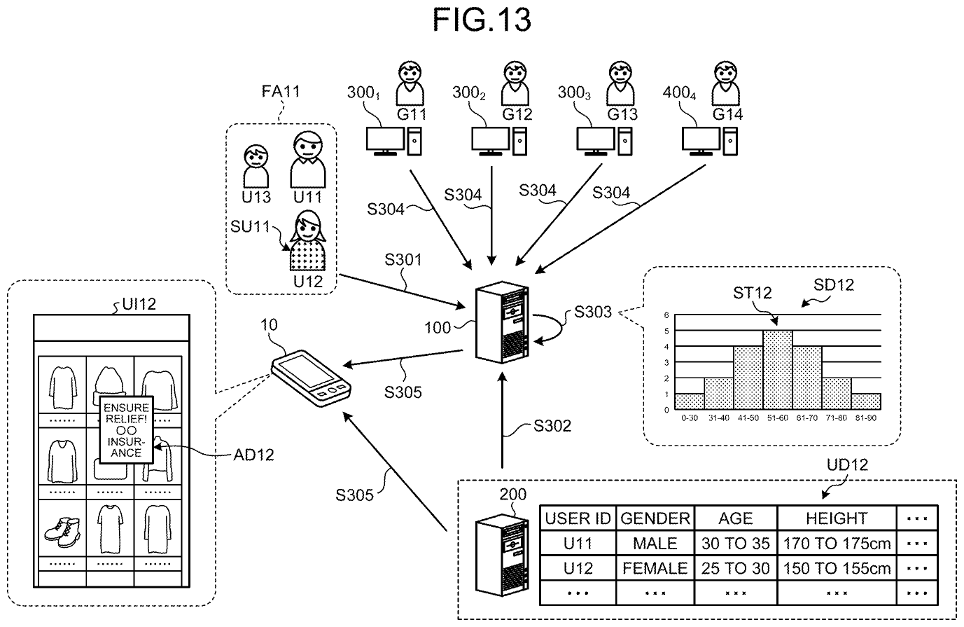

In FIG. 13, it is assumed that a proposal is given to the user U1 via the terminal apparatus 10, but explanation will be given based on the assumption that the user U11 who has an account has a family FA11 consisting of a user U12 and a user U13, and the user U12 and the user U13 are also associated with the account of the user U11. In the following, explanation will be given based on the assumption that the user U12 is a spouse of the user U11 and the user U13 is a child of the user U11. Meanwhile, in the following, for convenience of explanation, a case will be described in which three users are associated with a single account, but embodiments are not limited to this example, and the number of a plurality of users is not specifically limited. Meanwhile, in the following, a case will be described in which the user U12 wears clothes SU11 and body shape information on the user U12 will be measured.

The information processing apparatus 100 acquires body shape information on the user U12 among the plurality of users associated with the single account (Step S301). Meanwhile, the information processing apparatus 100 may identify the user who is wearing the clothes SU11 based on input that is performed by the user U11 or based on a measurement result that is obtained by measurement by the clothes SU11 and pieces of user information on the users included in the family FA11, for example. For example, if the measurement result indicates the body shape information on a female size, the information processing apparatus 100 identifies the user who is wearing the clothes SU11 among users with attributes indicating females.

The information processing apparatus 100 acquires pieces of body shape information on the plurality of users based on the attribute information on the user U12 (Step S302). Meanwhile, the attribute information on the user U12 may be identified by registration information that is registered by the user U11 on the predetermined electronic mall. For example, the attribute information on the user U12 may be identified by attribute data UD12.

The information processing apparatus 100 identifies a standard body shape ST12 based on statistical data SD12.

The information processing apparatus 100 compares the body shape information on the user U12 and the body shape information on the standard body shape ST12, and calculates a difference between the body shape of the user U12 and the standard body shape ST12 (Step S303).

The information processing apparatus 100 acquires the body shape information on the target user of each of the business operators (Step S304).

The information processing apparatus 100 provides information on an advertisement that is suitable for the user U12 among advertisements of a business operator for which the body shape information on the target user includes the body shape information on the user U12 in accordance with the difference from the standard body shape ST12.

A screen UI12 is one example of a UI screen for providing an advertisement that is suitable for the user U12. The screen UI12 is, for example, a content of a web service that provides the predetermined electronic mall that is managed by the management server 200. The screen UI12 is displayed based on information that is provided by the management server 200. Further, the screen UI12 includes an advertisement space AD12 for displaying the advertisement suitable for the user U12 in a predetermined area. The advertisement that is displayed in the advertisement space AD12 is displayed based on information that is provided by the information processing apparatus 100. In FIG. 12, an advertisement related to an insurance of the business operator G11 is displayed in the advertisement space AD12.

The screen UI12 may include a display space for displaying information for proposing approach to the standard body shape ST12, although not illustrated in the drawings. For example, the screen UI12 may include a display screen for displaying proposal of “this level of body shape is recommended based on information on your spouse” as one example of the information for proposing approach to the standard body shape ST12. In the display space, it may be possible to display information on the standard body shape ST12, such as “standard weight is 51 to 55 kg”, or information on the difference from the body shape information on the standard body shape ST12, such as “weight of your spouse is heavier by 10 kg, so let's lose 10 kg. With this configuration, the information processing apparatus 100 is able to promote health maintenance of the user U12 even from the viewpoint of healthcare.

The screen UI12 may include a display space for displaying information on clothes that fit the current body shape of the user U12 and that are available for purchase in the predetermined electronic mall that is managed by the management server 200, although not illustrated in the drawings. For example, it may be possible to display a proposal of “following clothes are recommended as clothes that fit current body shape of your spouse” as one example of the information for proposing clothes that fit the current body shape of the user U12. Similarly, the screen UI12 may include a display space for displaying information on clothes that fit the body shape of the standard body shape ST12 and that are available for purchase in the predetermined electronic mall that is managed by the management server 200. For example, it may be possible to display a proposal of “celebrity ∘∘A has worn clothes ∘∘B, but body shape of your spouse is ∘∘C, so how about recommending that your spouse loses weight?” as one example of the information for proposing clothes that fit the body shape of the standard body shape ST12.

Meanwhile, in the modification as described above, for convenience of explanation, the case has been described in which the family FA11 of the user U11 has a single female, but in some cases, there may be a case in which the family has a plurality of females. For example, there may be a case in which the child is a girl. In this case, the identification unit 136 may identify a target user for an advertisement or a target user for whom a change of the body shape is to be determined, based on, for example, information that is received in advance from user U11 (for example, registration information).

Meanwhile, in the modification as described above, the plurality of users may be associated with the single account based on the information that is received from the user U11, but embodiments are not limited to this example. For example, the estimation unit 133 may estimate a family structure of the user U11 based on information on the purchased product included in the purchase history, estimate attribute information on a plurality of estimated users, and associate the plurality of estimated users. Specifically, if the user U11 has purchased three kinds of clothes with different target attributes, the estimation unit 133 may estimate that the family of the user U11 consists of three persons, estimate attribute information on the estimated three persons based on the respective target attributes, and associate the three estimated users and the three kinds of clothes.

### 9. Effects

As described above, the information processing apparatus 100 according to one embodiment includes the first acquisition unit 131, the second acquisition unit 132, the calculation unit 134, and the providing unit 137. The first acquisition unit 131 acquires body shape information on a body shape of a first user. The second acquisition unit 132 acquires body shape information on a target user that is determined in advance as a user to whom information is to be provided by an information provider. The calculation unit 134 calculates, based on comparison between the body shape information on the first user acquired by the first acquisition unit 131 and statistical data of body shape information that is based on attribute information on the first user, a difference from a standard body shape that is based on the statistical data. The providing unit 137 provides information that is suitable for the first user among pieces of information of the information provider for which the body shape information on the target user includes the body shape information on the first user in accordance with the difference that is calculated by the calculation unit 134.

With this configuration, the information processing apparatus 100 according to one embodiment is able to perform targeting for information providing in accordance with the difference between the body shape of the user and the standard body shape. Therefore, the information processing apparatus 100 according to one embodiment is able to perform targeting for information providing suitable for the business operator without transmitting personal information on the user to the business operator, so that it is possible to prevent damage of the personal information and promote improvement in services in accordance with the body shape of the user.

Further, the calculation unit 134 calculates the difference based on statistical data of body shape information that is provided by a server that manages a predetermined electronic mall. Furthermore, if it is determined that the difference is equal to or larger than a predetermined threshold, the providing unit 137 provides information suitable for the first user such that the information is distributed on a web service that provides the predetermined electronic mall.

With this configuration, the information processing apparatus 100 according to one embodiment is able to appropriately determine, on the server side, a target user to whom the information is to be provided, so that it is possible to promote improvement in services in accordance with the body shape of the user.

Moreover, the providing unit 137 provides information that is suitable for the first user while giving priority to information of a certain information provider that has made a bid for a distribution space for preferential distribution on the web service, as an information provider that has a predetermined relationship with a server that manages the predetermined electronic mall.

With this configuration, the information processing apparatus 100 according to one embodiment is able to preferentially provide information of the information provider that has made a bid for the distribution space, so that it is possible to appropriately perform targeting for information providing based on the bid.

Furthermore, the providing unit 137 provides information that is determined in advance as information to be proposed in an unhealthy state, with an increase in the difference.

With this configuration, the information processing apparatus 100 according to one embodiment is able to differentiate information providing in accordance with the difference, so that it is possible to appropriately perform targeting for information providing.

Moreover, the information processing apparatus 100 according to one embodiment further includes the determination unit 135 that determines a change of the body shape of the first user based on the body shape information on the first user. Furthermore, if the determination unit 135 determines that the body shape of the first user is changed, the providing unit 137 dynamically changes information to be provided to the first user.

With this configuration, the information processing apparatus 100 according to one embodiment is able to dynamically change the information to be provided in accordance with the change of the body shape of the user, so that it is possible to appropriately perform targeting for information providing.

Moreover, the determination unit 135 determines a change of a purchase history of the first user based on a purchase history of the first user. Furthermore, if the determination unit 135 determines that the purchase history of the first user is changed, the providing unit 137 dynamically changes information to be provided to the first user.

With this configuration, the information processing apparatus 100 according to one embodiment is able to dynamically change the information to be provided in accordance with a change of the purchase history of the user, so that it is possible to appropriately perform targeting for information providing.

Moreover, the providing unit 137 provides information on a privilege that is given with acquisition of the body shape information on the first user, that is available in the predetermined electronic mall, and that relates to a privilege that is increased as the body shape of the first user approaches the standard body shape.

With this configuration, the information processing apparatus 100 according to one embodiment is able to promote improvement in motivation in approaching the standard body shape based on a privilege to be given. Further, with this configuration, the information processing apparatus 100 according to one embodiment is able to promote improvement in motivation, so that it is possible to increase in revenue and profit due to information providing.

### 10. Hardware Configuration

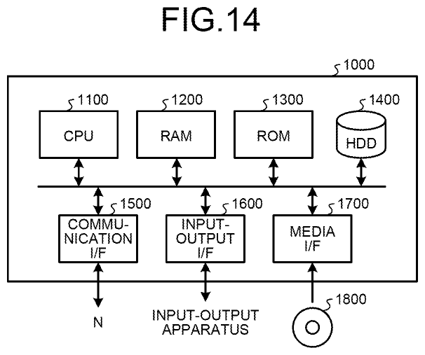

The terminal apparatus 10, the information processing apparatus 100, and the management server 200, and the business operator apparatus 300 according to one embodiment as described above are implemented by, for example, a computer 1000 as illustrated in FIG. 14. FIG. 14 is a hardware configuration diagram illustrating an example of the computer that implements the functions of, the terminal apparatus 10, the information processing apparatus 100, the management server 200, and the business operator apparatus 300. The computer 1000 includes a CPU 1100, a RAM 1200, a ROM 1300, an HDD 1400, a communication interface (I/F) 1500, an input-output interface (I/F) 1600, and a media interface (I/F) 1700.

The CPU 1100 operates based on a program that is stored in the ROM 1300 or the HDD 1400 and controls each of the units. The ROM 1300 stores therein a boot program that is executed by the CPU 1100 when the computer 1000 is activated, a program that is dependent on hardware of the computer 1000, or the like.

The HDD 1400 stores therein the program that is executed by the CPU 1100, data that is used by the program, and the like. The communication interface 1500 receives data from a different apparatus via a predetermined communication network, sends the data to the CPU 1100, and transmits data generated by the CPU 1100 to a different apparatus via the predetermined communication network.

The CPU 1100 controls an output apparatus, such as a display or a printer, and an input apparatus, such as a keyboard or a mouse, via the input-output interface 1600. The CPU 1100 acquires data from the input apparatus via the input-output interface 1600. Further, the CPU 1100 outputs generated data to the output apparatus via the input-output interface 1600.

The media interface 1700 reads the program or the data that is stored in a recording medium 1800, and provides the program or the data to the CPU 1100 via the RAM 1200. The CPU 1100 loads the program from the recording medium 1800 onto the RAM 1200 via the media interface 1700, and executes the loaded program. The recording medium 1800 is, for example, an optical recording medium, such as a Digital Versatile Disc (DVD) or a phase change rewritable Disk (PD), a magneto optical recording medium, such as a Magneto-Optical disk (MO), a tape medium, a magnetic recording medium, a semiconductor memory, or the like.

For example, when the computer 1000 functions as the terminal apparatus 10, the information processing apparatus 100, and the management server 200, and the business operator apparatus 300 according to one embodiment, the CPU 1100 of the computer 1000 executes programs that are loaded on the RAM 1200 and implements the functions of the control units 14, 130, 230 and 340. The CPU 1100 of the computer 1000 reads the programs from the recording medium 1800 and executes the programs; however, as another example, it may be possible to acquire the programs from a different apparatus via a predetermined communication network.

### 11. Others

Of the processes described in the embodiments, all or part of a process described as being performed automatically may also be performed manually. Alternatively, all or part of a process described as being performed manually may also be performed automatically by known methods. In addition, the processing procedures, specific names, and information including various kinds of data and parameters illustrated in the above-described document and drawings may be arbitrarily changed unless otherwise specified. For example, various kinds of information illustrated in each of the drawings are not limited to the information illustrated in the drawings.

Furthermore, the components illustrated in the drawings are functionally conceptual and do not necessarily have to be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions.

Moreover, the embodiments as described above may be combined appropriately as long as no contradiction is derived in the processing contents.

While some embodiments of the present application have been described in detail above based on the drawings, the embodiments are described by way of example, and the present invention may be embodied in various other forms with various changes or modifications based on knowledge of a person skilled in the art, in addition to the embodiments described in “Description of Embodiments”

In addition, “a section, a module, or a unit” described above may be replaced with “a means” or “a circuit”. For example, the acquisition unit may be replaced with an acquisition means or an acquisition circuit.

### REFERENCE SIGNS LIST

1 information processing system
10 terminal apparatus
11 communication unit
12 input unit
13 output unit
14 control unit
100 information processing apparatus
110 communication unit
120 storage unit
121 body shape information storage unit
122 purchase history storage unit
123 user information storage unit
124 bid information storage unit
130 control unit
131 first acquisition unit
132 second acquisition unit
133 estimation unit
134 calculation unit
135 determination unit
136 identification unit
137 providing unit
141 reception unit
142 transmission unit
200 management server
210 communication unit
220 storage unit
221 purchase history storage unit
222 user information storage unit
223 clothes information storage unit
230 control unit
231 acquisition unit
232 providing unit
300 business operator apparatus
310 communication unit
320 input unit
330 output unit
340 control unit
341 acquisition unit
342 transmission unit
N network

1. An information processing apparatus including a processor configured to:
acquire body shape information on a body shape of a first user;
acquire body shape information on a target user that is determined in advance as a user to whom information is to be provided by an information provider;
based on comparison between the body shape information on the first user and statistical data of body shape information that is based on attribute information on the first user, calculate a difference from a standard body shape that is based on the statistical data; and
provide the first user with information that is suitable for the first user among pieces of information of the information provider for which the body shape information on the target user includes the body shape information on the first user in accordance with the calculated difference.

2. The information processing apparatus according to claim 1, wherein the processor is further configured to:
calculate the difference based on statistical data of body shape information that is provided by a server that manages a predetermined electronic mall, and
in response to determining that the difference is equal to or larger than a predetermined threshold, provide the first user with the information suitable for the first user such that the information is distributed on a web service that provides the predetermined electronic mall.

3. The information processing apparatus according to claim 2, wherein the processor is further configured to provide the first user with the information that is suitable for the first user while giving priority to information of a certain information provider that has made a bid for a distribution space for preferential distribution on the web service, as an information provider that has a predetermined relationship with a server that manages the predetermined electronic mall.

4. The information processing apparatus according to claim 1, wherein the processor is further configured to provide the first user with information that is determined in advance as information to be proposed in an unhealthy state, with an increase in the difference.

5. The information processing apparatus according to claim 1, the processor is further configured to:
determine a change of the body shape of the first user based on the body shape information on the first user; and
in response to determining that the body shape of the first user is changed, dynamically change the information to be provided to the first user.

6. The information processing apparatus according to claim 1 wherein the processor is further configured to:
determine a change of a purchase history of the first user based on a purchase history of the first user, and
in response to determining that the purchase history of the first user is changed, dynamically change the information to be provided to the first user.

7. The information processing apparatus according to claim 1, wherein the processor is further configured to provide the first user with information on a privilege that is given with acquisition of the body shape information on the first user, that is available in the predetermined electronic mall, and that relates to a privilege that is increased as the body shape of the first user approaches the standard body shape.

8. An information processing method implemented by a computer, the information processing method including:
acquiring body shape information on a body shape of a first user;
acquiring body shape information on a target user that is determined in advance as a user to whom information is to be provided by an information provider;
based on comparison between the acquired body shape information on the first user statistical data of body shape information based on attribute information on the first user, calculating a difference from a standard body shape that is based on the statistical data; and
providing the first user with information that is suitable for the first user among pieces of information of the information provider for which the body shape information on the target user includes the body shape information on the first user in accordance with the calculated difference.

9. A non-transitory tangible machine-readable medium having an information processing program that, when executed by the computer, causes the computer to:
acquire body shape information on a body shape of a first user;
acquire body shape information on a target user that is determined in advance as a user to whom information is to be provided by an information provider;
based on comparison between the body shape information on the first user acquired at the first acquisition step and statistical data of body shape information based on attribute information on the first user, calculate a difference from a standard body shape that is based on the statistical data; and
provide the first user with information that is suitable for the first user among pieces of information of the information provider for which the body shape information on the target user includes the body shape information on the first user in accordance with the calculated difference.
